(19) United States
(12) Patent Application Publication
(10) Pub. No.: US 2024/0417521 A1
(43) Pub. Date: Dec. 19, 2024

(54) FABRICATION OF ELASTOMER BASED NANOCOMPOSITES

(71) Applicant: The Penn State Research Foundation, University Park, PA (US)

(72) Inventors: Arash Dahi Taleghani, University Park, PA (US); Seyedeh Maryam Tabatabaei, University Park, PA (US)

(21) Appl. No.: 18/698,567

(22) PCT Filed: Oct. 26, 2022
(86) PCT No.: PCT/US2022/047810

§ 371 Date: Apr. 4, 2024

Related U.S. Application Data
(60) Provisional application No. 63/276,159, filed on Nov. 5, 2021.

(51) Int. Cl. C08J 3/20; C08J 3/16; C08J 9/00; C08K 9/04

(52) U.S. Cl. CPC C08J 3/203; C08J 3/16; C08J 9/008; C08J 9/009; C08K 9/04; C08J 2300/26; C08K 2201/011

(57) ABSTRACT

A method of fabricating a composite material can include adding particulate material to an elastomeric material. The particulate material can include expanded graphite particulates and/or graphite nanoplatelet particulates. The particulate material can be diffused within the elastomeric material to uniformly disperse the particulate material within the elastomeric material. The elastomeric material having the particulate material dispersed therein can then be cured after the diffusing to form a structure comprised of the composite material, the composite material including the elastomeric material and the particulate material. In some embodiments, surfaces of the particulate material can be modified to include carboxyl and hydroxyl groups before the particulate material is added to the elastomeric material to facilitate improved bonding of the particulate material. In some embodiments, the formed structure can be configured as or for use in a gasket, seal, vibration dampening device or sound reduction device.

### CROSS-REFERENCE TO RELATED APPLICATIONS

The present application claims priority to U.S. Provisional Patent Application No. 63/276,159, which was filed on Nov. 5, 2021. The entirety of this application is incorporated by reference herein.

### FIELD OF THE INVENTION

The present innovation relates to elastomers and methods of fabricating and using elastomers.

### BACKGROUND OF THE INVENTION

Elastomer materials are often used in the oil and gas industry. Examples of such elastomers include nitrile butadiene rubber (NBR), ethylene propylene diene monomer (EPDM), hydrogenated nitrile butadiene rubber (HNBR), fluoroelastomers (FKM), perfluoroelastomers (FEPM), and perfluorocarbon elastomers (FFKM). FKM, FEPM, and FFKM are known to be very expensive and may provide low functionality at low temperatures as compared to NBR, EPDM, and HNBR. For instance, FKM and FFKM can cost between 10 and 100 times more than NBR. While elastomers like NBR provide a significant reduction in cost, such elastomers often struggle at high temperatures. For instance, in high temperature environments (e.g. an environment at which the elastomer is exposed to a temperature that is above 250° F., above 121.1° C., above 148.9° C., or above 300° F.), the elastomer material may fail to provide its designed function.

For instance, at such high temperatures, NBR may be unable to effectively and reliably resist gas and/or moisture permeation. In geothermal well applications, for example, NBR may risk decomposition and degradation that can result in formation of elastomer cracking and/or elastomer softening that can deteriorate the ability of the elastomer to provide a desired sealing, shock absorbing and/or noise reduction function. For example, as a result of such deterioration of the elastomeric material, hydraulic integrity of geothermal wells could be comprised and can reduce the efficiency at which thermal energy extraction occurs. Such deterioration can also result in environmental damages occurring if the leakage is not addressed in a timely fashion.

### SUMMARY OF THE INVENTION

We have determined that a new elastomeric material is needed to provide an improved performance as compared to conventional elastomers while also permitting a reduction in cost-particularly for high temperature applications (e.g. elastomer use in environments that may be at a temperature of over 250° F., over 121° C., over 148.9° C., or over 300° F.). Embodiments of our elastomeric material can be configured to provide improved mechanical properties while also avoiding excessive deformation, decomposition, and/or degradation at higher temperatures (e.g. a temperature over 300° F. (148.9° C.), a temperature up to 400° F. (204.44° C.), a temperature over 400° F. (204.44° C.), etc.). In some embodiments, it is contemplated that the elastomeric material can avoid deformation, decomposition, and/or degradation at temperatures as high as 400° F. (or 204.44° C.).

In some embodiments, an elastomeric material can be formed by adding nanofillers into the elastomeric matrix for forming the elastomeric material. The nanofiller material can include graphite nanoplatelet (GNP) and/or expandable graphite (EG). In comparison to carbon nanotubes or graphene, the GNP and/or EG fillers may provide significant cost savings. The use of GNP and/or EG can provide an improved performance of the underlying elastomeric material being modified via the nanoparticle fillers at a significantly lower cost.

In some embodiments, an elastomeric material can be formed by providing an elastomeric matrix, dispersing GNP nanoparticles and/or EG nanoparticles into the matrix to provide a uniform dispersion of the GNP nanoparticles and/or EG nanoparticles into the elastomeric matrix, and introducing a surface treatment for the nanoparticles into the matrix to help improve the diffusion of the particles within the elastomeric matrix and to ensure a strong bond between the GNP nanoparticles and/or EG nanoparticles and the elastomer matrix. The combination of a relatively uniform dispersion of the GNP nanoparticles and/or EG nanoparticles and the strong bond of these nanoparticles and the matrix can efficiently enhance the resistance that the elastomeric material may have to loading-unloading conditions to improve the ability of the material to restrict or prevent formation and propagation of radial cracking or other types of mechanical failure or degrading. The elastomeric matrix having the GNP nanoparticles and/or EG nanoparticles added therein can therefore provide improved material properties for use in higher temperature conditions as compared to a conventional elastomeric material. Such elastomer composite materials having the GNP nanoparticles and/or EG nanoparticles can be used in gaskets, seals, noise reduction applications and/or vibration dampening applications in higher temperature environments to provide improved performance. Their inclusion in such applications can also require less maintenance work as compared to devices utilizing a conventional elastomeric material for such applications. In addition, embodiments of the elastomer composite materials having the GNP nanoparticles and/or EG nanoparticles can provide a basis for new designs of gaskets, seals, noise reduction devices and/or vibration dampening devices specifically designed for higher temperature environments at which conventional elastomeric materials may not be suitable.

In a first aspect, a method of fabricating a composite material is provided that can include adding particulate material to an elastomeric material. The particulate material can include expanded graphite particulates (EGP) and/or graphite nanoplatelet (GNP) particulates. The method can also include diffusing the particulate material within the elastomeric material to uniformly disperse the particulate material within the elastomeric material, and molding the elastomeric material having the particulate material dispersed therein after the diffusing to form a structure comprised of the composite material. The composite material can include the elastomeric material and the particulate material. The molding process can utilize any suitable molding process for forming the structure from the composite material.

The diffusing that is performed can include diffusion. The diffusing can also include dispersing, which can include application of convection in combination with diffusing (e.g. stirring, vibration, or agitation in combination with diffusion, etc.).

In some implementations, the adding of the EGP and/or GNP to the elastomeric material (e.g. elastomeric material or elastomeric compounds) can be performed so that the EGP and/or GNP material are present in a concentration range of 0.01 volume percent (vol %) to 5 vol % with the balance being the elastomeric material (e.g. elastomeric material or elastomeric compound material) may comprise up to 95-99.99 vol % of the mixture in some embodiments). In other implementations, the adding of the EGP and/or GNP to the elastomeric material (e.g. elastomeric material or elastomeric compounds) can be performed so that the EGP and/or GNP material are present in a concentration range of 0.01 vol % to 10 vol % with the balance being the elastomeric material (e.g. elastomeric material or elastomeric compound material) may comprise up to 90-99.99 vol % of the mixture in some embodiments. The concentration of the EGP and/or GNP material in such embodiments can be a cumulative concentration (e.g. the concentration of the EGP and the concentration of GNP within a mixture when added together can be between 0.01 vol % to 10 vol % or between 0.01 vol % and 5 vol %, etc.). For instance, a concentration of EGP of 0.2 vol % and a concentration of GNP of 0.2 vol % can result in a concentration of 0.4 vol % of the EGP and GNP material when that material is added to the elastomeric material in an embodiment. This example is exemplary in nature. Various other concentration combinations of EGP and/or GNP can also be utilized in embodiments.

In a second aspect, the method of the first aspect can also include modifying surfaces of the particulate material before the particulate material is added to the elastomeric material.

In a third aspect, the modifying of the surfaces of the particulate material can include adding carboxyl and hydroxyl groups onto the surfaces of the particulate material.

In a fourth aspect, the adding of the carboxyl and hydroxyl groups can include mixing the particulate material into a mixture of sulfuric acid, phosphoric acid and/or nitric acid, stirring the mixture of sulfuric acid, phosphoric acid and/or nitric acid including the particulate material mixed therein at a pre-selected temperature (e.g. a high temperature, a temperature of 80° C., a temperature in a range of 40° C. to 70° C., 50° C. to 150° C., 50° C. to 275° C., or a temperature in another suitable temperature range) for a pre-selected stirring time period before washing the mixture of sulfuric acid, phosphoric acid and/or nitric acid having the particulate material mixed therein. The pre-selected stirring time can be a time within a suitable time range, such as, for example, 2 hours, four hours, a time range of between 20 minutes and 5 hours, a time range of between 30 minutes and 8 hours, or a time range of between 1 hour and 6 hours. The washing of the particulate material can be continued until a clear solution is obtained on top of the particles to facilitate subsequent separation the particulate material from the solution positioned above the particulate material for subsequently diffusing the particulate material into the elastomeric material.

In a fifth aspect, the diffusing of the particulate material within the elastomeric material can include adding the particulate material having the carboxyl and hydroxyl groups added to the surfaces to a polar compatibilizer solution to form a mixture, evaporating a solvent of the polar compatibilizer solution, and comminuting the particulate material having the polar compatibilizer with elastomeric material to diffuse the particulate material within the elastomeric material. The elastomeric material can be a formed elastomeric material or can be elastomeric compounds that can be used to subsequently form an elastomeric structure. In some embodiments, the solvent used in the fifth aspect can be any suitable solvent such as toluene, ethanol, or hexane.

In a sixth aspect, the solvent used in any aspect discussed herein can be any suitable solvent. In some embodiments, the solvent can be water or deionized water. In other embodiments, the solvent can be toluene, ethanol, hexane, an alcohol, or another type of suitable solvent.

In a seventh aspect, the diffusing of the particulate material within the elastomeric material can include adding the particulate material having the carboxyl and hydroxyl groups added to the surfaces to a solvent and mixing the solvent having the particulate material added therein to elastomeric material or latex (e.g. an aqueous colloidal dispersion of polymer) to form a mixture and stirring the mixture for a stirring time period to diffuse the particulate material within the elastomeric material or latex.

In an eighth aspect, the diffusing of the particulate material within the elastomeric material can include dispersing the particulate material having the carboxyl groups and hydroxyl groups added to the surfaces in ethanol to form an integration mixture, and mixing the integration mixture with the elastomeric material until the ethanol is evaporated. The elastomeric material within the integration mixture can be a formed elastomeric material or can be elastomeric compounds that can be used to subsequently form an elastomeric structure. The elastomeric material can be integrated with the dispersion to form an elastomeric component, for example (e.g. an O-ring, a gasket, etc.). In some implementations of the eighth aspect, the diffusing can also include foaming the elastomeric material after the mixing to form the structure so that a body of the structure is cellular.

In a ninth aspect, the diffusing of the particulate material within the elastomeric material can include adding the particulate material having the carboxyl groups and hydroxyl groups added to the surfaces to a first solvent to form an integration mixture, adding the integration mixture to the elastomeric material (e.g. the elastomeric material can be a liquid elastomeric material) and mixing the integration mixture and the elastomeric material, and evaporating the first solvent. The elastomeric material can be a formed elastomeric material or can be elastomeric compounds that can be used to subsequently form an elastomeric structure. Some implementations of the ninth aspect can be implements so that vulcanizing agents are used to make the liquid form of the elastomeric material before the adding of the integration mixture to the elastomeric material occurs. In some embodiments, the diffusing of the particulate material within the elastomeric material can also include adding a coagulation element to a homogenous phase of the integration mixture mixed with the elastomeric material.

In a tenth aspect, evaporating of the first solvent can occur via drying. The drying can also evaporate a second solvent in embodiments that utilize both a first solvent and a second solvent (e.g. an embodiment of the above discussed ninth aspect).

In an eleventh aspect, after the evaporation of the solvent, a viscous mixture can be generated or formed. In some implementations, this mixture can be poured into a mold to be cured therein.

In a twelfth embodiment, diffusing of the particulate material within the elastomeric material can include adding the particulate material having the carboxyl groups and hydroxyl groups added to their surfaces to a first solvent to form an integration mixture. The elastomeric material can be a formed elastomeric material or can be elastomeric compounds that can be used to subsequently form an elastomeric structure. Some implementations of this aspect can be implemented so that the elastomeric material is dissolved into a second solvent before the adding of the integration mixture to the elastomeric material or elastomeric compounds occurs. The diffusing of the particulate material within the elastomeric material or elastomeric compounds can also include adding a coagulation element to a homogenous phase of the integration mixture mixed with the elastomeric material or elastomeric compounds. Some implementations of this aspect may use a mixture of curing agents and the dried coagulation form of the composite in a hot press. In such embodiments, a drying process can be utilized that facilitates evaporating of the first solvent as well as the second solvent in embodiments that utilize both a first solvent and a second solvent.

In a thirteenth aspect, the diffusing of the particulate material within the elastomeric material can include comminuting the particulate material with the elastomeric material. The elastomeric material can be a formed elastomeric material or can be elastomeric compounds that can be used to subsequently form an elastomeric structure.

In a fourteenth aspect, the method can also include incorporating the structure into a seal, a gasket, vibration dampening device, or a sound reduction device.

In a fifteenth aspect, the structure can be a particular type of device. For example, the structure can be a gasket, a seal, or an o-ring. Alternatively, the structure can be configured for incorporation into a device (e.g. a seal, a gasket, a vibration dampening device, or a sound reduction device, etc.).

In a sixteenth aspect, the method of the first aspect can include one or more of the second through fifteenth aspects. For example, the method of the first aspect can include the thirteenth and fourteenth aspects as well as the second, third, and fourth aspects. As another example, the first aspect can include one of the fifth aspect, sixth aspect, the eighth or the ninth aspect in combination with at least one of the second aspect, third aspect, fourth aspect, seventh aspect, tenth aspect, eleventh aspect, twelfth aspect, thirteenth aspect, fourteenth aspect and/or fifteenth aspect.

In a seventeenth aspect, a composite material is provided. Embodiments of the material can be formed via an embodiment of the method discussed above, for example. The composite material can include an elastomeric material having particulate material uniformly distributed and bonded therein. The particulate material can include expanded graphite (EG) particulates and/or graphite nanoplatelet (GNP) particulates. The particulate material can be nano-particulate material or can include nano-particulate material in some embodiments.

In an eighteenth aspect, a structure is provided. The structure can be a device such as a seal, a gasket, vibration dampening device, or a sound reduction device. The structure can also be a component of a device such as a component of a seal, a gasket component, a component of a vibration dampening device, or a component of a sound reduction device. The structure can include a composite material (e.g. a material of the seventeenth aspect or a material formed from one of the above discussed embodiments for fabricating a composite material or one of the below discussed embodiments of a method for fabricating a composite material). In some embodiments, the structure can be molded from the composite material that is formed from a method for example. An embodiment of the method that can be used to form the composite material can include an embodiment discussed below or an embodiment discussed above.

In yet another aspect, a method can include using graphite nanoplatelets in conjunction with nanoclays to improve thermal resistance and resiliency of an elastomeric material. Examples of embodiments of this method can include embodiments discussed above.

Other details, objects, and advantages of the invention will become apparent as the following description of certain present preferred embodiments thereof and certain present preferred methods of practicing the same proceeds.

### BRIEF DESCRIPTION OF THE DRAWINGS

Exemplary embodiments of our elastomer based compositions and methods of making and using the same are shown in the accompanying drawings. It should be appreciated that like reference numbers used in the drawings may identify like components.

FIG. 1 is a flow chart illustrating a first exemplary embodiment of a method of making an elastomer based composite material having nanoparticles dispersed within an elastomeric material to provide improved high temperature degradation and/or mechanical properties. Optional steps of this first exemplary embodiment of the method are shown in broken line in FIG. 1.

FIG. 2 is a schematic flow chart illustrating an exemplary process by which the surface of nanoparticles to be included in an elastomeric matrix can be modified prior to the modified nanoparticles being included in an elastomeric matrix for formation of an elastomeric composite material.

FIG. 3 is a perspective view of an exemplary gasket device that can provide at least one of: a seal, vibration dampening and noise reduction that is composed of an exemplary embodiment of our elastomeric composite having nanoparticles dispersed therein.

### DETAILED DESCRIPTION OF PRESENT PREFERRED EMBODIMENTS

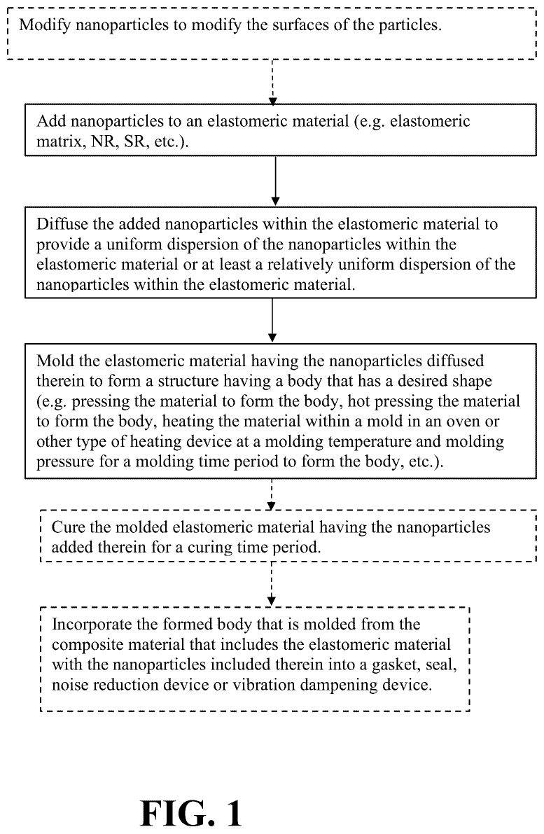

Referring to FIGS. 1-3, an elastomeric based composite material or a polymeric based composite material can be formed to include a structure 1 that can be configured as a gasket, a seal, a noise reduction device, or a vibration dampening device or be incorporated into a gasket, a seal, a noise reduction device, or a vibration dampening device. The structure 1 can include a body 3 that defines at least one opening 5. In other embodiments, the body 3 can be a solid structure or a structure that is not annular in configuration (e.g. a hollow spherical structure, a solid disk-like structure, etc.).

In some embodiments, the structure 1 can be configured as an o-ring or a disk, for example. In other embodiments, the structure 1 can have a polygonal shape, an annular polygonal shape, an irregular shape, or be designed for inclusion as a component of a gasket, a seal, a noise reduction device, or a vibration dampening device.

The body 3 can be composed of an elastomeric based composite material that has microparticles or nanoparticles dispersed therein and bonded therein. The microparticles or nanoparticles diffused within the elastomer material of the body 3 can include a range of 0.01 volume percent (vol %) to 5 vol % of the composition of the body and the elastomeric material may comprise up to 95-99.99 vol % of the body in some embodiments (e.g. the body composition can be 0.2 vol % GNP or EG particles with 99.8 vol % silicone rubber). In some embodiments, the microparticles or nanoparticles diffused within the elastomer material of the body 3 can include a range of 0.01 vol % to 10 vol % of the composition of the body and the elastomeric material may comprise up to 90-99.9 vol % of the body in some embodiments (e.g. the body composition can be 1.5 vol % GNP or EG particles with 98.5 vol % silicone rubber). In yet other embodiments, the microparticles or nanoparticles diffused within the elastomer material of the body 3 can include a range of 0.01 vol % to 15 vol % of the composition of the body and the elastomeric material may comprise up to 85-99.99 vol % of the body in some embodiments (e.g. the body composition can be 1.0 vol % GNP or EG particles with 99.0 vol % silicone rubber or be 3.0 vol % GNP or EG particles with 97.0 vol % silicone rubber, etc.).

The elastomeric material can include, for example, natural rubber (NR), epoxidized natural rubber (ENR), NBR, EPDM, or HNBR. In yet other embodiments, the elastomeric body 3 can be composed of a polymeric material that has nanoparticles dispersed and bonded therein. The polymeric material can include, for example, synthetic rubbers such as NBR, silicone rubber, EPDM, or HNBR as well as other types of polymeric materials.

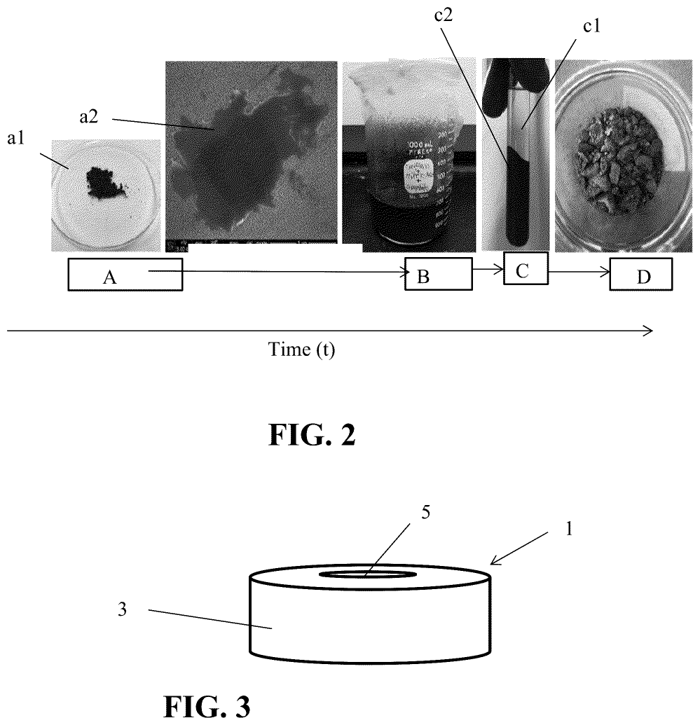

The body 3 of the structure 1 can be formed via different processing procedures. For example, as shown in FIGS. 1-2, the body 3 can be formed by preparing polymer nanocomposites that can be prepared via in situ polymerization or the solution compounding method. The nanoparticles that are included in the composite structure can be modified via surface modification by adding functional groups such as functional acids (e.g. (—COOH) or other groups (e.g. —OH)) to the surface of the nanoparticles. In some embodiments, the modification of the surfaces of the nanoparticles with carboxyl (—COOH) and hydroxyl (—OH) groups can enhance the physical and chemical interaction between the nanoparticles and the polymeric material or elastomeric material.

For example, the nanoparticles can be graphite nanoplatelet (GNP) particles or expanded graphite (EG) particles, or a combination of GNP particles and EG particles. In embodiments that use EG particles, the EG particles can be thermally expanded graphite flakes (EGF). Such particles can undergo surface modification with carboxyl (—COOH) and/or hydroxyl (—OH) group to enhance the physical and chemical interaction between the nanoparticles and the polymeric material or elastomeric material to which they are to be added. It should be appreciated that the surface modification of the nanoparticles can allow the nanoparticles to be more effectively bonded to the polymeric or elastomeric material to which they are to be added by altering the non-reactive ion groups on the surface of the nanoparticles.

Nanoparticles can refer to particulates that have a thickness of less than 50 nanometers and a planar dimensions (e.g. length or width) that is less than 50 micrometers. For instance, in some embodiments, the nanoparticles can have a planar dimension of 25 micrometers and a thickness (or diameter) of 6-8 nanometers. In other embodiments, the nanoparticles can have a thickness (or diameter) of less than 6 nanometers or larger than 8 nanometers (e.g. 10 nm, 7-15 nm, 10-20 nm, less than 50 nm, less than 12 nm, between 4 and 15 nm, etc.) and have a different planar dimension (e.g. length or height) that is less than 25 micrometers (e.g. 1 micrometer, 2-8 micrometers, less than 20 micrometers, etc.) or other value that is less than 50 micrometers (e.g. less than 40 micrometers, between 20-40 micrometers, etc.).

In some embodiments, macroparticles can include particulates that have a planar dimension that can vary from about 10 micrometers up to about 800 micrometers. For instance, expanded graphite flakes (EGFs) may have this type of planar dimension variance for EGF nanoparticles. The length of such particulates can be about millimeter sized. For instance, the thickness of such particulates can be in the 0.1-1 mm range, or the 1-5 mm range.

Exemplary fabrication of exemplary nanocomposite structures will now be discussed herein with reference to FIGS. 1-2.

### Example 1-Fabrication Of Natural Rubber (NR) and GNP nanocomposite

In a first example (Example 1), we fabricated an NR and GNP nanocomposite structure using an exemplary methodology. An example of this methodology is generally described in FIG. 1, which identifies optional steps of the method in broken line boxes of the flow chart illustrated therein.

### Surface Modification Of GNP Particles

First, the graphite nanoplatelet (GNP) particles underwent surface modification to add carboxyl and hydroxy groups to their surfaces. Then, a polar compatibilizer was used to prepare a mixture composed of the surface-modified GNP particles to be added to the compounds of the natural rubber (NR).

With reference to FIG. 2, the surface modification of the GNP particles occurred by first providing the GNP particles in a first step A. The particles were nano-sized particles as can be appreciated from the image a1 of the GNP particles prior to surface modification and the microscopy image a2 of the GNP particles. As can be appreciated from the microscopy image a2 of the GNP particles, the particles had a 25 micrometer lateral dimension and a thickness of about 6 nanometers (i.e. 6 nm +/−1 nm) for this particular example. The GNP particles can be introduced to a mixture of sulfuric and nitric acids as shown in second step B. The mixture of sulfuric and nitric acid had a weight ratio of 3:1. For this particular example, nitric acid with a concentration of 70 wt. % and sulfuric acid with a concentration of 96 wt. % have been used. The GNP particles mixed with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid c1 on top of the GNP particles c2 was obtained, as can be seen from third step C in FIG. 2. Thereafter, the clear top solution was separated from the bottom GNP particles. Fourth step D in FIG. 2 illustrates the final prepared surface modified GNP particles utilizing the surface modification process embodiment of FIG. 2.

In this particular example, a mixture of sulfuric acid and nitric acid was utilzied. In other embodiments, it is contemplated that phosphoric acid could be used to replace the sulfuric acid or that a mixture of sulfuric acid, phosphoric acid, and nitric acid could be used instead of a mixture of nitric acid and sulfuric acid. It should therefore be appreciated that there are altnerative embodiments of the methodology for surface modification of the graphite particualte materials that can be utilized.

### Fabrication Of Polar Caompatibilizer/Surface Modified GNP Particles

The surface modified GNP particles were subsequently added to an elastomeric matrix. The elastomeric matrix used in this first example (Example 1) was an epoxidized natural rubber (ENR) that was used as a polar compatibilizer between the polar surface-modified GNP particles and the nonpolar natural rubber to be utilized in a subsequent step. First, the ENR was dissolved in toluene by stirring continuously at room temperature. The weight ratio of ENR to the toluene was 1:3. Then, as the mixture of the solvent and ENR was stirring, 50 parts per hundred rubber (phr) of the surface modified GNP particles were added to the ENR/tolulene mixture. After the GNP particles were added, the formed mixture having the ENR, tolulene, and surface modified GNP particles underwent sonication for 30 minutes to produce a uniform dispersion of the surface modified GNP particles within the ENR matrix. Thereafter, the formed solution was kept still in the open air for complete evaporation of the solvent. After evaporation of the solvent, an ENR/surface modified GNP particle composite film was produced for adding to bulk natural rubber (NR).

### Formation of NR Composite Via Open Two Roll Mixing Mill

After the ENR/surface modified GNP particle composite film was produced, the film was mixed with a natural rubber (NR) material. The film and the NR material was then comminuted using an open two roll mixing mill to mill the material. The weight percent of the surface modified GNP particles within the milled mixture was 3 weight percent (3 wt %). A compression molding machine was then used for vulcanization of the rubber compounds to form a structure 1 of the NR composite material including the surface modified GNP particles. The curation process of the rubber/GNP particle composite was performed at 150° C. with an optimum curing time that can be obtained from rheometer analysis.

### Example 2-Fabrication Of NR/GNP Nanocomposite

In a second example (Example 2), GNP particles were directly inserted to compounds of bulk NR using an open two roll mixing mill. This occurred without any surface modification of the GNP particles for this second example. The weight percentage of the GNP particles to the NR was 3 wt % for this example. After this mixture was formed, a compression molding machine was then used for vulcanization of the mixture to form a structure 1 of the NR composite material including the non-surface modified GNP particles. The curation process of the rubber/GNP particle composite was performed at 150° C. with the optimum curing time that can be obtained from rheometer analysis.

### Example 3-Formation of NR/Surface Modified GNP Nanocomposite

In a third example (Example 3), graphite nanoplatelet (GNP) particles underwent surface modification to add carboxyl and hydroxyl groups to their surfaces. With reference to FIG. 2, the surface modification of the GNP particles occurred by first providing the GNP particles in a first step A. The particles were nano-sized particles as can be appreciated from the image a1 of the GNP particles prior to surface modification and the microscopy image a2 of the GNP particles. As can be appreciated from the microscopy image a2 of the GNP particles, the particles had a 25 micrometer lateral dimension and a thickness of about 6 nanometers (i.e. 6 nm +/−1 nm) for this particular example. The GNP particles can be introduced to a mixture of sulfuric and nitric acids as shown in second step B. The mixture of sulfuric and nitric acid had a weight ratio of 3:1. For this particular example, nitric acid with a concentration of 70 wt. % and sulfuric acid with a concentration of 96 wt. % have been used. The GNP particles mixed with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid c1 on top of the GNP particles c2 was obtained, as can be seen from third step C in FIG. 2. Thereafter, the clear top solution was separated from the bottom GNP particles. Fourth step D in FIG. 2 illustrates the final prepared surface modified GNP particles utilizing the surface modification process embodiment of FIG. 2.

The surface modified GNP particles were subsequently added to deionized water, which was used as a solvent in this third example (Example 3). This water/surface modified GNP mixture was then integrated with natural rubber latex using magnetic stirring for 30 minutes. Bubbles formed during the stirring were then removed by a process of homogenization, followed by 10 minutes of sonication. The generated mixture of NR latex, GNP particles, and deionized water was then poured into a mold and placed in an oven at 70° C. until the material was thoroughly dry. This process was used to prepare a natural rubber/modified surface GNP particle nanocomposite having different concentrations of nanofillers that ranged from 0.01 wt % to 10 wt. % nanofillers of the dried natural rubber composite material. The matrix of the composite material was NR for these different compositions.

### Example 4-Fabrication Of Synthetic Polymeric Rubber (SR)/Surface Modified GNP Nanocomposite

In this fourth example (Example 4), silicone rubber (SR), a polymeric synthetic rubber having a cellular structure, was utilized to form a polymeric GNP nanoparticle composite

The GNP particles had their surfaces modified as discussed above for this Example 4. With reference to FIG. 2, the surface modification of the GNP particles occurred by first providing the GNP particles in a first step A. The particles were nano-sized particles as can be appreciated from the image a1 of the GNP particles prior to surface modification and the microscopy image a2 of the GNP particles. As can be appreciated from the microscopy image a2 of the GNP particles, the particles had a 25 micrometer lateral dimension and a thickness of about 6 nanometers (i.e. 6 nm +/−1 nm) for this particular example. The GNP particles can be introduced to a mixture of sulfuric and nitric acids as shown in a second step B. The mixture of sulfuric and nitric acid had a weight ratio of 3:1. For this particular example, nitric acid with a concentration of 70 wt. % and sulfuric acid with a concentration of 96 wt. % have been used. The GNP particles mixed with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid c1 on top of the GNP particles c2 was obtained. Thereafter, the clear top solution was separated from the bottom GNP particles. Fourth step D in FIG. 2 illustrates the final prepared surface modified GNP particles utilizing the surface modification process embodiment of FIG. 2.

The surface modified GNP particles were subsequently dispersed in ethanol using ultrasonication for five minutes and then overnight stirring the mixture of ethanol and the GNP particles. Then, the mixture was integrated with silicon hydrogen (SiH) compound using high shear mixing with the rate greater than about 5000 rpm for 30 minutes. The duration of this shear mixing was sufficient to completely evaporate the ethanol. At the end of this complete evaporation of the ethanol, a constant weight for the SiH and GNP particle mixture was achieved. This mixture was then mixed thoroughly with silicon hydroxide (SiOH) in the presence of a platinum (Pt) catalyst and hydrogen to facilitate foaming. The ratio of SiOH to the surface modified GNP particles/SiH mixture was 1:1. The formed cellular silicone rubber compound formed in this manner having the GNP particles was formed to include different concentrations of surface modified GNP of 0.10 wt %, 0.20 wt %, 0.25 wt %, and 0.30 wt % surface modified GNP in the formed silicone rubber composite material.

### Example 5-Fabrication Of Synthetic Polymeric Rubber (SR)/Surface Modified GNP Nanocomposite

In a fifth example (Example 5), vulcanized liquid SR was used for the preparation of the SR/surface modified GNP particle nanocomposite. The GNP particles had their surfaces modified as discussed above for this Example 5. With reference to FIG. 2, the surface modification of the GNP particles occurred by first providing the GNP particles in a first step A. The particles were nano-sized particles as can be appreciated from the image a1 of the GNP particles prior to surface modification and the microscopy image a2 of the GNP particles. As can be appreciated from the microscopy image a2 of the GNP particles, the particles had a 25 micrometer lateral dimension and a thickness of about 6 nanometers (i.e. 6 nm +/−1 nm) for this particular example. The GNP particles can be introduced to a mixture of sulfuric and nitric acids as shown in second step B. The mixture of sulfuric and nitric acid had a weight ratio of 3:1. For this particular example, nitric acid with a concentration of 70 wt. % and sulfuric acid with a concentration of 96 wt. % have been used. The GNP particles mixed with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid c1 on top of the GNP particles c2 was obtained. Thereafter, the clear top solution was separated from the bottom GNP particles. Fourth step D in FIG. 2 illustrates the final prepared surface modified GNP particles utilizing the surface modification process embodiment of FIG. 2.

The surface modified GNP particles were subsequently mixed with hexane. This wet mixture was then added to liquid SR and the resultant mixture was mechanically stirred and underwent sonication to get a uniform dispersion of the GNP nanoparticles within the matrix. After evaporation of the hexane solvent using a vacuum evaporator, the generated viscous mixture of SR and the surface modified GNP material was poured into a glass mold to be cured. For this Example 5, the concentration of GNP in the SR/surface modified GNP composite was less than 0.05 volume percent (vol %) GNP.

### Example 6-Fabrication Of A SR/EGF Nanocomposite

In this Example 6, a SR/EGF nanocomposite was formed similar to the above discussed Example 5. The EGF had their surfaces modified. The surface modification of the EGF occurred by first providing the EGF particles in a first step. The EGF were micron-sized flakes of expanded graphite prior to surface modification. The EGF had a planar dimension that varied from 10 micrometers to 800 micrometers. The EGF was introduced to a mixture of sulfuric and nitric acids in a second step. The mixture of sulfuric and nitric acid had a weight ratio of 3:1. For this particular example, nitric acid with a concentration of 70 wt. % and sulfuric acid with a concentration of 96 wt. % have been used. The ECF were mixed with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid on top of the EGF was obtained. Thereafter, in a fourth step the clear top solution was separated from the bottom EGF.

The surface modified EGF were subsequently mixed with hexane. This wet mixture was then added to liquid SR and the resultant mixture was mechanically stirred and underwent sonication to get a uniform dispersion of the EGF within the matrix. After evaporation of the hexane solvent using a vacuum evaporator, the generated viscous mixture of SR and the surface modified EGF material was poured into a glass mold shaped to define a body 3 for the structure 1. The material was then cured. For this Example 6, the concentration of EGF in the SR/surface modified EGF composite was less than 0.05 volume percent (vol. %) EGF.

### Example 7-Fabrication Of An NBR/Surface Modified GNP Nanocomposite

Graphite nanoplatelet particles underwent surface modification as discussed above for Example 7. The surface modification of the GNP particles occurred by first providing the GNP particles in a firs step A. The particles were nano-sized particles as can be appreciated from the image a1 of the GNP particles prior to surface modification and the microscopy image a2 of the GNP particles shown in FIG. 2. As can be appreciated from the microscopy image a2 of the GNP particles, the particles had a 25 micrometer lateral dimension and a thickness of about 6 nanometers (i.e. 6 nm +/−1 nm) for this particular example. The GNP particles can be introduced to a mixture of sulfuric and nitric acids as shown in second step B. The mixture of sulfuric and nitric acid had a weight ratio of 3:1. For this particular example, nitric acid with a concentration of 70 wt. % and sulfuric acid with a concentration of 96 wt. % have been used. The GNP particles mixed with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid c1 on top of the GNP particles c2 was obtained, as can be seen from third step C in FIG. 2. Thereafter, the clear top solution was separated from the bottom GNP particle in a fourth step. Fourth step D in FIG. 2 illustrates the final prepared surface modified GNP particles utilizing the surface modification process embodiment of FIG. 2.

The surface modified GNP particles were dispersed in a dimethylfuran solvent using ultrasonication for three hours. Next, a desired amount of NBR was cut into small pieces and dissolved into an organic solvent of acetone (400 mL). The process of the dissolution of the NBR was performed using magnetic stirring at 60° C. for 12 hrs. After complete dissolution of the NBR in the acetone, the mixture of the surface modified GNP particles in the dimethylfuran solvent was added to solution of the NBR and acetone and that resultant mixture was subsequently stirred at 60° C. for 12 hrs. After a homogenous phase was obtained, the stirring was stopped and deionized water was added to the mixture. The deionized water was stirred in by a spatula to prohibit sudden phase separation and was added slowly to the homogenous phase of the acetone, NBR, surface modified GNP particles and dimethylfuran mixture. After and during deionized water addition, the mixture coagulated so that coagulation formation occurred for the mixture. The generated NBR/surface modified GNP particles were dried in an oven under 80° C. Drying was continued until a constant weight of the material was obtained from the drying. Curing agents were mixed with the dried coagulated material in a two roll mill and the mixture of materials was milled to comminute and mix the material. The comminuted material was subsequently cured in a hot press for a curing time that was determined via results of rheometer analysis of the material. Using this process, material having different concentrations of the surface modified GNP particles were obtained having a GNP particle concentration in the range of greater than 0 to 2 parts per hundred parts of rubber (i.e. NBR).

### Example 8-Fabrication Of An NBR/Surface Modified EGF Nanocomposite

Thermally expanded graphite flake (EGF) particles underwent surface modification for this Example 8. The surface modification of the EGF particles occurred by first providing the EGF particles in a first step A. The particles were nano-sized particles. The EGF particles can be introduced to a mixture of sulfuric and nitric acids as shown in a second step B. The mixture of sulfuric and nitric acid had a weight ratio of 3:1. For this particular example, nitric acid with a concentration of 70 wt. % and sulfuric acid with a concentration of 96 wt. % have been used. The EGF with the mixture of the sulfuric acid and nitric acid were stirred at a high temperature, 80° C. for this case, for a period, about 8 hr in this example, using a magnetic sterrir to react, as shown in Step B. Then, the mixture in the beaker was consequtively washed with deionized water and acetone in a step C until a clear liquid c1 on top of the EGF particles c2 was obtained. Thereafter, the clear top solution was separated from the bottom EGF particles.

The surface modified EGF particles were dispersed in a dimethylfuran solvent using ultrasonication for three hours. Next, a desired amount of NBR was cut into small pieces and dissolved into an organic solvent of acetone (400 mL). The process of the dissolution of the NBR was performed using magnetic stirring at 60° C. for 12 hrs. After complete dissolution of the NBR in the acetone, the mixture of the surface modified EGF particles in the dimethylfuran solvent was added to solution of the NBR and acetone and that resultant mixture was subsequently stirred at 60° C. for 12 hrs. After a homogenous phase was obtained, the stirring was stopped and deionized water was added to the mixture. The deionized water was stirred in by a spatula to prohibit sudden phase separation and was added slowly to the homogenous phase of the acetone, NBR, surface modified EGF particles and dimethylfuran mixture. After and during deionized water addition, the mixture coagulated so that coagulation formation occurred for the mixture. The generated NBR/surface modified EGF particles were dried in an oven under 80° C. Drying was continued until a constant weight of the material was obtained from the drying. Curing agents were mixed with the dried coagulated material in a two roll mill and the mixture of materials was milled to comminute and mix the material. The comminuted material was subsequently cured in a hot press for a curing time that was determined via results of rheometer analysis of the material. Using this process, material having different concentrations of the surface modified EGF particles were obtained having a EGF particle concentration in the range of greater than 0 to 2 parts per hundred parts of rubber (i.e. NBR).

### Analysis Of Example Structures

Samples of the above examples underwent testing and analysis. This testing and analysis that have thus far been conducted indicated that the formed nanocomposite materials could withstand significantly greater temperatures and were able to better resist degradation due to the exposure to temperatures over 300° F. (148.9° C.). The formed structures of the examples discussed above also had improved mechanical properties that can better withstand abrasion and friction and can provide an improved capacity to resist the formation and propagation of cracking in a body formed from the composite material (e.g. enhanced ability to prevent and reduce radial cracking). Structures formed from the composite material can provide improved performance that permits the structures to be used in different, higher temperature applications and also provide improved wear profiles and a longer useful product life as compared to conventional structures used in high temperature environments for seal, gasket, vibration dampening and/or sound reduction applications.

It is contemplated that the improved performance provided by the GNP particle inclusion and/or EGF particle inclusion within the elastomeric material to form a structure 1 having a body 3 that is composed of the nanocomposite material is the uniform dispersion of the GNP particles and/or EGF particles within the elastomeric material. The methodology discussed herein for inclusion of the GNP particles and/or EGF particles is believed to provide an enhanced ability to uniformly distribute the particles within an elastomeric matrix material for forming the composite material. In addition to the uniform dispersion, the surface modification of the EGF and/or GNP particles provide for an improvement in bond strength between the particles and the elastomeric material (e.g. rubber or synthetic rubber). The combination of the improved bond strength and improvement in more uniformly distributing particles for inclusion in the elastomeric matrix material to form a composite structure are believed to provide a synergistic effect that provides an unexpected improvement in the mechanical properties of the formed composite as well as the improved thermal degradation properties of the composite.

As can be appreciated from the above, embodiments of a method of fabricating a composite material can include adding particulate material to an elastomeric material where the particulate material can include expanded graphite particulates and/or graphite nanoplatelet particulates. The particulate material can be diffused within the elastomeric material to uniformly disperse the particulate material within the elastomeric material. The elastomeric material can be a formed elastomeric material or can be elastomeric compounds that can be used to subsequently form an elastomeric structure. The elastomeric material having the particulate material dispersed therein can be molded after the diffusing to form a structure comprised of the composite material. The composite material can include the elastomeric material and the particulate material. The diffusing that is performed can include diffusion and can also include dispersing, which can include application of convection in combination with diffusion. The elastomeric material that is used can be formed elastomeric material or elastomeric compounds used to form elastomeric material.

In some implementations of the method, surfaces of the particulate material can be modified before the particulate material is added to the elastomeric material. Surface modification can occur prior to molding, for example.

The modifying of the surfaces of the particulate material can include adding carboxyl and hydroxyl groups onto the surfaces of the particulate material. The adding of the carboxyl and hydroxyl groups can include mixing the particulate material into a mixture of sulfuric acid, phosphoric acid and/or nitric acid; stirring the mixture of sulfuric acid, phosphoric acid and/or nitric acid including the particulate material at a high temperature before washing the mixture of sulfuric acid, phosphoric acid and/or nitric acid having the particulate material. The process of washing the particulate material can be continued until a clear solution is obtained on top of the particles to separate the particulate material for subsequently diffusing the particulate material into the elastomeric material.

In some embodiments in which the modifying of the surfaces occurs, the diffusing of the particulate material within the elastomeric material can include adding the particulate material having the carboxyl and hydroxyl groups added to the surfaces to a polar compatibilizer solution to form a mixture, evaporating a solvent of the polar compatibilizer solution; and comminuting the particulate material having the polar compatibilizer with elastomeric material to diffuse the particulate material within the elastomeric material.

In other embodiments, the diffusing of the particulate material within the elastomeric material can include adding the particulate material having the carboxyl and hydroxyl groups added to the surfaces to a solvent, mixing the solvent having the particulate material added therein to elastomeric material to form a mixture, and stirring the mixture for a stirring time period to diffuse the particulate material within the elastomeric material. The solvent can be water or deionized water. In other implementations, the solvent can be ethanol, hexane, acetone, or other type of suitable solvent.

In yet other embodiments in which the modifying of the surfaces occurs, the diffusing of the particulate material within the elastomeric material can include dispersing the particulate material having the carboxyl groups and hydroxyl groups added to the surfaces in a solvent (e.g. ethanol, hexane, etc.) to form an integration mixture and mixing the integration mixture with the elastomeric material until the solvent is evaporated.

In yet other embodiments in which the modifying of the surfaces occurs, the diffusing of the particulate material within the elastomeric material can include adding the particulate material having the carboxyl groups and hydroxyl groups added to the surfaces to a first solvent to form an integration mixture, adding the integration mixture to the elastomeric material and mixing the integration mixture and the elastomeric material, and evaporating the first solvent. In some implementations of the diffusing, the elastomeric material can be dissolved into a second solvent before the adding of the integration mixture to the elastomeric material occurs. This second solvent can also be evaporated when the first solvent is evaporated.

Evaporation of a solvent can occur via drying. Drying can occur in a number of ways (e.g. exposure to heat, exposure to heat and pressure, heating in an oven or other heating device, etc.).

In some embodiments, the diffusing of the particulate material within the elastomeric material can also include adding a coagulation element to a homogenous phase of the integration mixture mixed with the elastomeric material. At least one curing agent can also be added to the dried elastomeric material mixed with the particulate material and subsequently comminuted with the elastomeric material, particulate material and at least one curing agent. This can occur prior to molding. During the molding, the comminuted elastomeric material, particulate material, and at least one curing agent can be pressed together (e.g. pressed or compressed) for forming the structure.

In yet other embodiments, the diffusing of the particulate material within the elastomeric material can include comminuting the particulate material with the elastomeric material.

Embodiments of the method can also be performed so that the diffusing of the particulate material within the elastomeric material also includes foaming the elastomeric material to form the structure 1 so that a body of the structure is cellular. The foaming can occur during or after elastomeric material and the particulate material are mixed together.

The formed structure can be incorporated into a seal, a gasket, vibration dampening device, or a sound reduction device. For instance, the structure can be configured for incorporation into a seal, a gasket, vibration dampening device, or a sound reduction device (e.g. be a component of such a device). Alternatively, the formed structure can be a gasket, an o-ring, or a seal. In yet other embodiments, the formed structure is another type of device or a component of another type of device.

It should be appreciated that the embodiments of our method can result in formation of a composite material. The composite material can include an elastomeric material having particulate material uniformly distributed and bonded therein. The particulate material can include expanded graphite particulates and/or graphite nanoplatelet particulates. The particulate material can be a type of nano-particulate material.

It should be appreciated that modifications can be made to the above discussed embodiments to meet a particular set of design criteria. For instance, the type of residence time or stirring time utilized in different embodiments of the method can be refined to meet a particular set of design criteria. As another example, the type of elastomeric material and particulate material that is utilzied can be adjusted to meet a particular set of design criteria. As yet another example, the type of nanofiller material that may be utilized as particulate material can include graphite nanoplatelet (GNP) and/or expandable graphite (EG). Example of EG material can include EGF or other type of EG particulate material. As yet another example, the type of molding that may be utilized to form a structure 1 can be any suitable molding process for a particular set of design criteria and the shape and size of that structure 1 can be adapted to accommodate a particular set of design criteria.

It should therefore be understood that while certain present preferred embodiments of our elastomer based compositions and embodiments of methods for making and using the same have been shown and described above, it is to be distinctly understood that the invention is not limited thereto but may be otherwise variously embodied and practiced within the scope of the following claims.

We claim:

1. A method of fabricating a composite material comprising:
adding particulate material to an elastomeric material, the particulate material comprising expanded graphite particulates and/or graphite nanoplatelet particulates;
diffusing the particulate material within the elastomeric material to uniformly disperse the particulate material within the elastomeric material; and
molding the elastomeric material having the particulate material dispersed therein after the diffusing to form a structure comprised of the composite material, the composite material including the elastomeric material and the particulate material.

2. The method of claim 1, comprising:
modifying surfaces of the particulate material before the particulate material is added to the elastomeric material.

3. The method of claim 2, wherein the modifying of the surfaces of the particulate material comprises:
adding carboxyl and hydroxyl groups onto the surfaces of the particulate material.

4. The method of claim 3, wherein the adding of the carboxyl and hydroxyl groups includes mixing the particulate material into a mixture of sulfuric acid, phosphoric acid and/or nitric acid; stirring the mixture of sulfuric acid, phosphoric acid and/or nitric acid including the particulate material at a pre-selected temperature before washing the mixture of sulfuric acid, phosphoric acid and/or nitric acid having the particulate material mixed therein.

5. The method of claim 4, wherein the adding of the carboxyl and hydroxyl groups also includes separating a clear solution formed from the washing from the particulate material to separate the particulate material for subsequently diffusing the particulate material into the elastomeric material.

6. The method of claim 5, wherein the diffusing of the particulate material within the elastomeric material comprises:
adding the particulate material having the carboxyl and hydroxyl groups added to the surfaces to a polar compatibilizer solution to form a mixture;
evaporating a solvent of the polar compatibilizer solution; and
comminuting the particulate material having the polar compatibilizer with elastomeric material to diffuse the particulate material within the elastomeric material.

7. The method of claim 5, wherein the diffusing of the particulate material within the elastomeric material comprises:
adding the particulate material having the carboxyl and hydroxyl groups added to the surfaces to a solvent; and
mixing the solvent having the particulate material added therein to elastomeric material to form a mixture and stirring the mixture for a stirring time period to diffuse the particulate material within the elastomeric material.

8. The method of claim 7, wherein the solvent is water or deionized water.

9. The method of claim 5, wherein the diffusing of the particulate material within the elastomeric material comprises:
dispersing the particulate material having the carboxyl groups and hydroxyl groups added to the surfaces in ethanol to form an integration mixture; and
mixing the integration mixture with the elastomeric material until the ethanol is evaporated.

10. The method of claim 9, wherein the diffusing of the particulate material within the elastomeric material also comprises:
foaming the elastomeric material after the mixing to form the structure so that a body of the structure is cellular.

11. The method of claim 5, wherein the diffusing of the particulate material within the elastomeric material comprises:
adding the particulate material having the carboxyl groups and hydroxyl groups added to the surfaces to a first solvent to form an integration mixture;
adding the integration mixture to the elastomeric material and mixing the integration mixture and the elastomeric material; and
evaporating the first solvent.

12. The method of claim 11, wherein the elastomeric material is dissolved into a second solvent before the adding of the integration mixture to the elastomeric material occurs.

13. The method of claim 12, wherein the diffusing of the particulate material within the elastomeric material also comprises:
adding a coagulation element to a homogenous phase of the integration mixture mixed with the elastomeric material; and
wherein the evaporating of the first solvent occurs via drying, the drying also evaporating the second solvent.

14. The method of claim 13, comprising:
adding at least one curing agent to the dried elastomeric material mixed with the particulate material and subsequently comminuting the elastomeric material, particulate material and at least one curing agent; and
and wherein the molding includes pressing the comminuted elastomeric material, particulate material, and at least one curing agent for forming the structure.

15. The method of claim 1, wherein the diffusing of the particulate material within the elastomeric material comprises:
comminuting the particulate material with the elastomeric material.

16. The method of claim 3, comprising:
incorporating the structure into a seal, a gasket, vibration dampening device, or a sound reduction device.

17. The method of claim 1, wherein the structure is a gasket, an o-ring, or a seal.

18. The method of claim 1, wherein the structure is configured for incorporation into a seal, a gasket, vibration dampening device, or a sound reduction device.

19. A composite material comprising:
an elastomeric material having particulate material uniformly distributed and bonded therein, the particulate material comprising expanded graphite particulates and/or graphite nanoplatelet particulates.

20. The composite material of claim 19, wherein the particulate material is nano-particulate material.

21. A method comprising:
using graphite nanoplatelets in conjunction with nanoclays to improve thermal resistance and resiliency of an elastomeric material.
